(19) United States
(12) Patent Application Publication
(10) Pub. No.: US 2016/0373369 A1
(43) Pub. Date: Dec. 22, 2016

(54) DATA TRANSFER VIA A COMMUNICATION DEVICE

(71) Applicant: OMICRON ELECTRONICS GMBH, Klaus (AT)

(72) Inventors: Fred Steinhauser, Klaus (AT); Michael Jochum, Altach (AT); Tal Yehiely, Koblach (AT)

(21) Appl. No.: 14/902,405

(22) PCT Filed: Jul. 4, 2014
(86) PCT No.: PCT/EP2014/064336

§ 371 Date: Dec. 31, 2015

(30) Foreign Application Priority Data
Jul. 4, 2013 (EP) 13175105.9

(51) Int. Cl. H04L 12/863

(52) U.S. Cl. CPC H04L 47/6255; H04L 47/56

(57) ABSTRACT

The present invention relates to a method (600) for data transfer via a communication device (100). The communication device (100) is configured to receive data via an input (Rx, A), to output the received data via an output (Tx, B) of the communication device (100), and to output additional data via the output (Tx, B). In the course of the method, data are received via the input (Rx, A) and are stored temporarily in an intermediate data memory (110). The intermediate data memory (110) has a predetermined size. Moreover, the data stored temporarily are output via the output (Tx, B). In addition, a size of a data area not used by the received data in the intermediate data memory (110) is determined, and additional data are output via the output (Tx, B) in a manner depending on this size.

The present invention relates to a method for data transfer via a communication device and also to a corresponding communication device. The present invention relates, in particular, to a method for bidirectional data transfer via a communication device in communications networks with time-distribution protocols.

In a communications network, for example a data-transfer network, that couples together various computing units and control units, for example in a power supply system, a temporally precise control and acquisition of information may be of great importance. For this purpose, the systems connected to one another via the communications network may respectively exhibit individual clocks which can be synchronised, for example by exchanging synchronisation messages via the communications network. An example of a method of such a type is the time-synchronisation according to standard IEEE 1588. In this method, the transit-times of the data packets between the clocks of the various systems are measured and compensated. Prerequisites for the functioning of such a method are that the transit-times are constant and symmetrical, i.e. the delay in both directions is identical. Use is frequently made of networks of the Ethernet type as communications networks, and the data packets exchanged between the clocks are forwarded by Ethernet switches.

FIG. 1 shows a network of such a type, to which two systems with clocks 901 and 902 have been linked. The clocks 901 and 902 may be, for example, clocks or timing devices of corresponding computer systems or control systems. The clocks 901 and 902 have been coupled with one another via the network. The network may have an arbitrary size. For example, the network may have been installed within a building, or the network may extend, via appropriate long-range networks, over distances of several hundred or several thousand kilometres. As is known in the state of the art, the network may comprise several network hubs, for example Ethernet switches 501, 502 and 503 as well as connections 500 between the Ethernet switches 501-503. The connections 500 may, for example, comprise electrical or optical data connections. The data packets for time-synchronisation between the clocks 901 and 902 are exchanged via the Ethernet switches 501-503 as well as the connections 500. Typically, other appliances—such as, for example, the appliance 200—have also been linked to a network of such a type. These other appliances generate additional data traffic on the network, which can interfere with the data packets for time-synchronisation exchanged between the clocks 901 and 902. The data traffic between two appliances that have not been linked to the same Ethernet switch is forwarded via the connections 500 between the Ethernet switches 501-503. The connections 500 are also designated as trunk links. These trunk links have been linked to trunk ports 510. The data packets can ordinarily pass through a trunk port only in succession. As a result, it may happen that a data packet for the time-synchronisation of the two clocks 901 and 902 cannot be forwarded immediately via the trunk link 500, since precisely one data packet is output from the appliance 200 via the trunk port 510. The data packet for the time-synchronisation is consequently delayed until the sending of the data packet from the appliance 200 has been concluded. As a result, the throughput-times of the data packets through the Ethernet switches 501-503 are indeterminate, and the residence-times of the data packets in the Ethernet switches 501-503 may vary. Therefore conventional Ethernet switches, which exhibit none of the suitable precautionary measures described in the following, are not suitable to be employed in networks with precise time-synchronisation. For this case, specially equipped Ethernet switches 501-503 are needed which, for example, exhibit a so-called transparent mode. Ethernet switches of such a type determine the actual residence-times of the data packets in the switch, and communicate these residence-times to the clocks 901 and 902. On the basis of the knowledge of the actual throughput-time through the Ethernet switches 501-503, the clocks can take this into consideration and consequently synchronise themselves. An arrangement in which the throughput-time is ascertained and communicated is also designated as a transparent clock. However, the effort for the implementation of an arrangement of such a type with a transparent-clock method is considerable, and the hardware, i.e. the structure of the Ethernet switches, has to meet certain prerequisites, depending on the demanded precision.

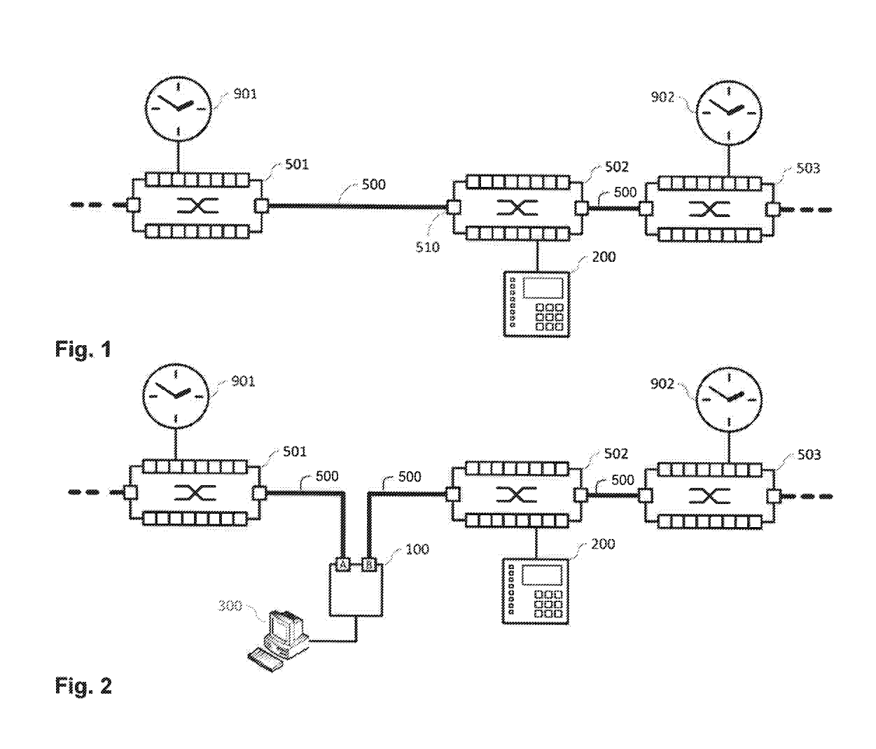

In a communications network it may furthermore be necessary that a further appliance 100 is looped into one of the connections 500 of the communication path between the two clocks 901 and 902, as is shown in FIG. 2. Appliance 100 may, for example, be used for monitoring the communication on the network for diagnostic purposes. Network ports A and B of appliance 100, which are connected to the connections 500 for the purpose of looping appliance 100 in, are designated as inline ports. Appliance 100 is operated locally from, for example, a computer 300. Appliance 100 may, for example, route the data through unchanged between the inline ports A and B, i.e. the data are forwarded from inline port A to inline port B or forwarded in the opposite direction from inline port B to inline port A and, where appropriate, tapped. However, appliance 100 does not feed any of its own data packets into the trunk link 500, i.e. no data packets of its own are despatched via the inline ports A and B. An appliance 100 of such a type that has been looped in for the purpose of monitoring is also designated as a tap. Following this nomenclature, the network connection 500 into which the tap is looped is called the tapped link. The manner in which appliance 100 is able to forward the data packets is variable. In the case of a so-called passive tap, the inline ports A and B have been connected to one another on the physical layer. The signals are tapped on the physical layer in appliance 100, and the logical levels are recovered therefrom. The data packets consequently pass through appliance 100 practically without delay from the one inline port to the other inline port. An active tap, on the other hand, reads in the data packets from an inline port, and after this sends them out again at the other inline port. This can be realised, for example, with a store-and-forward method, in which the data packets in their entirety are read in before they are sent on. The delay in the forwarding of data packets in this method is accordingly dependent on the size of the data packet. In order to minimise the residence-time of a data packet in appliance 100, however, the sending can already be begun again before the entire data packet has been read in. A method of such a type is designated as a cut-through method. The forwarding begins, for example, after a certain portion of the data packet has been read in. In the case of the cut-through method the throughput-time is consequently independent of the packet size and can consequently be realised to be constant.

If the throughput-time is constant and symmetrical, appliance 100, which operates, for example, in accordance with the previously described cut-through method, appears like an additional piece of connecting line with a certain length. The delays caused thereby can consequently be easily compensated by a time-synchronisation mechanism. To the extent that appliance 100 only forwards data packets between the inline ports and, where appropriate, taps them, but despatches no data packets of its own via the inline ports A, B, the mode of operation of the time-synchronisation between the clocks 901 and 902 can be realised, for example, in accordance with IEEE 1588.

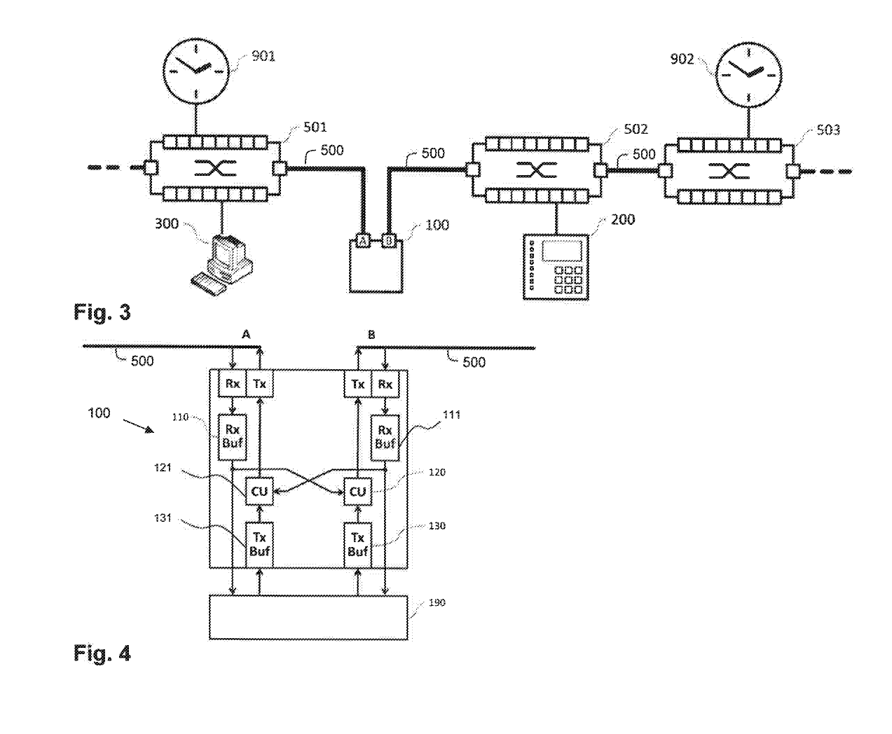

In conventional networks, however, cases may arise in which appliance 100 additionally sends out self-generated data packets via the inline ports A and/or B; for example, if appliance 100 is not being operated locally via the computer 300 linked thereto, as is shown in FIG. 2, but if appliance 100 is being remote-controlled via the inline ports A, B. Also in the case, if appliance 100 is to forward recorded data via the tapped link to, for example, a central processing station, there is a need to output data packets generated by appliance 100 via the inline ports A and B. FIG. 3 shows a situation of such a type, in which the computer 300 for controlling appliance 100 has no longer been locally and directly linked to appliance 100 but has been linked to switch 501. The exchange of data between the computer 300 and appliance 100 for the purpose of controlling appliance 100 now takes place via the tapped link 500. This exchange of data may, for example, take place bidirectionally, i.e. via inline port A appliance 100 will receive packets from the computer 300 and will send out data packets for the computer 300. In this case, in which data packets generated by appliance 100 itself are sent out via the inline ports A, B, a conflict situation may occur in which the data packet generated by appliance 100 is simultaneously to be transmitted with a data packet to be forwarded via the connection 500 through appliance 100. A situation of such a type may lead to a delay of one of the data packets. For example, the data packet coming later or generated later in the given case can be delayed until an earlier incoming or generated data packet has been completely despatched. If appliance 100 has, for example, already begun to send a self-generated data packet to switch 501 via inline port A, appliance 100 will firstly despatch the entire self-generated data packet, and only after this will begin to forward a data packet that was received from switch 502 at inline port B for forwarding to switch 501. As a result, however undefined delays may occur in the forwarding of data packets between the switches 501 and 502, which, in turn, can disturb the operation of the time-synchronisation between the clocks 901 and 902. With the implementation of a transparent-clock process in appliance 100, the operation of the time-synchronisation between the clocks 901 and 902 could be secured also in the case previously described. However, as previously described, an implementation of a transparent-clock method is relatively elaborate.

It is therefore an object of the present invention to provide a method for data transfer for, for example, appliance 100 that can be realised with little effort and does not disturb the operation of the time-synchronisation between the clocks 901 and 902.

This object is achieved, according to the present invention, by a method for data transfer via a communication device according to claim 1 and by a communication device according to claim 11. The dependent claims define preferred and advantageous embodiments of the invention.

According to the present invention, a method is provided for data transfer via a communication device. The communication device is capable of receiving data via an input of the communication device, and of outputting, via an output of the communication device, the data received via the input. Furthermore, the communication device is configured to output additional data via the output. The additional data may, for example, comprise data that were not received via the input but, for example, were generated by the communication device itself. In the course of the method, the data are received via the input and stored temporarily in an intermediate data memory. The intermediate data memory has a predetermined size. The intermediate data memory may, for example, have a size that enables the communication device to store temporarily complete data packets that are transmitted in a data network connected to the communication device. In conventional data-transfer networks the size of data packets has ordinarily been limited to a certain size. The intermediate data memory may, for example, have such a size that data packets of this maximum size can be stored temporarily therein. The intermediate data memory may, for example, be configured by the type of a so-called FIFO intermediate memory (first in first out), i.e. the data that are input into the intermediate memory are output again from the intermediate memory in the same sequence. The intermediate memory can store and output the data with a predetermined clock pulse, for example. In the course of the method, the data stored temporarily are output via the output. Moreover, in the course of the method a size of a data area not used by the received data in the intermediate data memory is determined. Expressed otherwise, a size of a currently free data area in the intermediate data memory is determined, this data area currently being not used by the received data, and consequently being unused. The additional data—that is to say, for example, the data generated by the communication device itself—are output in a manner depending on the size of the data area not used by the received data. Expressed otherwise, a size of a gap in a data stream of the received data is determined, and the additional data are output via the output in a manner depending on the size of this gap in the data stream. Inasmuch as the data received via the input are firstly stored temporarily or buffered in the intermediate memory, it can be determined in straightforward manner whether in the received data a data gap is present that is large enough to output the additional data via the output during this data gap. Inasmuch as the received data are, in principle, stored temporarily in the intermediate memory, and the intermediate memory has a predetermined size, the received data can be precisely delayed for a predetermined time before they are output via the output. In the case of the synchronisation method previously described with reference to FIGS. 1-3 it can therefore be ensured that the transit-times of data through the communication device—which, for example, may be appliance 100—are constant. As a result, the synchronisation method is not disturbed even when the additional data are output via the output of the communication device.

According to an embodiment, the determination of the size of the data area not used by the received data includes a determination of whether the intermediate data memory is empty. Expressed otherwise, in this embodiment it is determined whether the intermediate data memory is empty, and, depending on whether it is empty or not, the additional data are output via the output. The intermediate data memory may, for example, have been dimensioned in such a way that it is suitable for storing a data packet that is as large as possible in the communications network. Alternatively, the intermediate data memory may have been dimensioned in such a way that it could store a data packet consisting of the additional data with a maximum size. If the intermediate data memory is empty, a sufficiently large data gap is consequently present in the data received via the input in order to be able to output the additional data via the output without this output of data colliding with the output of data received via the input. As a result, it can be ensured that the data received via the input are always output at the output with the same delay, and consequently the transit-time of the data through the communication device is constant.

According to a further embodiment, in the course of the intermediate storage the received data are routed through the intermediate data memory at a predetermined speed. Inasmuch as the received data are routed at the predetermined speed through the intermediate data memory with predetermined size before they are output at the output, the data are delayed by a defined time, so that the transit-times of the data through the communication device are constant, and consequently the previously described synchronisation method is not disturbed by the communication device.

With a further embodiment, the received data are stored temporarily in the intermediate data memory for a precisely predetermined time. As a result, the transit-time of the data through the communication device is constant, and the time-synchronisation method described at the outset can be carried out undisturbed in a communications network that includes the communication device.

According to a further embodiment, the data comprise data packets, each data packet comprising several data units. By way of data units the data packet may comprise, for example, several bits or bytes. In the course of the intermediate storage of the received data each data unit is stored temporarily for a precisely predetermined time. Consequently, for example, the data of a data packet can be clocked into the intermediate data memory and read out of the intermediate data memory in bit-synchronous or byte-synchronous manner, so that a transmission of, for example, synchronisation packets of a time-synchronisation through the communication device takes place transparently and with constant transit-time.

According to a further embodiment, the additional data are stored temporarily in an additional intermediate data memory before the additional data are output via the output. The additional data may, for example, be present in the form of data packets. In the additional intermediate data memory a data packet of the additional data or several data packets of the additional data can consequently be stored temporarily, for example. By virtue of the intermediate storage of the additional data, a data gap that is needed in the data stream from the input to the output can be ascertained, said data gap being needed in order to insert a data packet of the additional data into the data flow between the input and the output in such a manner that no collision arises with the data from the input. As a result, the additional data can be reliably inserted into the data stream between the input and the output without influencing the throughput-time of the data from the input to the output.

According to a further embodiment, the communication device is capable of receiving further data via a further input of the communication device, and of outputting the further data received via the further input via a further output of the communication device. Furthermore, the communication device is configured to output further additional data via the further output. In this embodiment, the further data are received via the further input, and the further data received via the further input are stored temporarily in a further intermediate data memory. The further intermediate data memory has a size that is equal to the predetermined size of the intermediate data memory. The data stored temporarily in the further intermediate data memory are output via the further output. A size of a data area not used by the received further data in the further intermediate data memory is determined, and the further additional data are output via the further output in a manner depending on the size of the data area not used by the further received data in the further intermediate data memory. Consequently two independent data streams can be processed by the communication device. The two independent data streams can, for example, support a bidirectional communication in a communications network. The additional data or the further additional data may, for example, comprise data generated by the communication device, and may be fed in an arbitrary direction of the bidirectional communication, provided that an appropriate gap arises in the corresponding direction of the data to be routed through. Inasmuch as the additional data or the further additional data are inserted into gaps of the data stream to be routed through, the transit-times of the data to be routed through are constant. Inasmuch as the intermediate data memory and the further intermediate data memory have an identical size, the transit-times in both directions are constant and consequently symmetrical, so that a delay of a transport of data through the communication device occurs in each direction with constant and identical transit-time. As a result, the communication device can be inserted into, for example, the communications network described in connection with FIGS. 1-3 without influencing synchronisation processes between the clocks.

According to the present invention, moreover a communication device is provided that comprises an input for receiving data, an output for outputting data, an intermediate data memory with a predetermined size, and a control device. The control device is configured to receive data via the input and to store them temporarily in the intermediate memory. Furthermore, the control device is capable of outputting the data stored temporarily in the intermediate data memory via the output. Moreover, the control device determines a size of a data area not used by the received data in the intermediate data memory, and outputs additional data via the output in a manner depending on the size of the unused data area in the intermediate data memory determined in this way. The communication device consequently is configured to carry out the previously described method or one of its embodiments and therefore also exhibits the advantages described in connection with the method previously described.

The present invention will be elucidated in the following with reference to the drawings on the basis of preferred embodiments.

FIG. 1 shows schematically a communications network with two clocks which can be synchronised with one another via a time-synchronisation method.

FIG. 2 shows the communications network of FIG. 1 with an appliance coupled into a communications connection.

FIG. 3 shows the communications network of FIG. 2, wherein the coupled appliance is controlled via a remote control device.

FIG. 4 shows schematically a communication device according to an embodiment of the present invention.

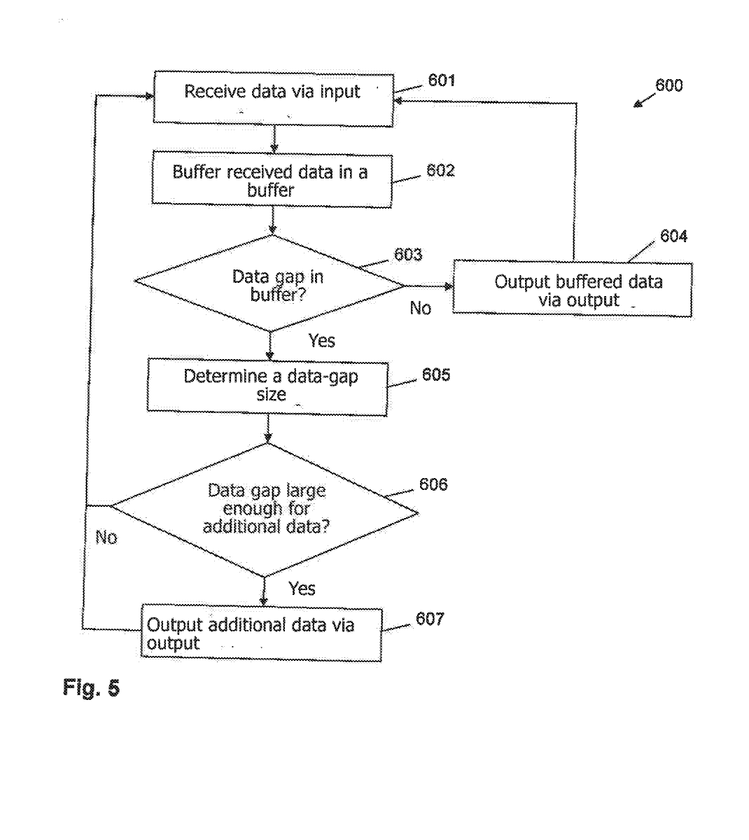

FIG. 5 shows steps of a method for data transfer via a communication device according to an embodiment of the present invention.

FIG. 4 shows a communication device 100 which, for example, can be employed as appliance 100 in the communications network of FIG. 3. The communication device 100 includes two bidirectional ports A, B which have been connected to communications connections 500. As is shown in FIG. 3, port A may, for example, have been coupled with switch 501 via the communications connection 500, and port B may have been coupled with switch 502 via the connection 500. The communication device 100 consequently forwards data, in particular data packets, between the switches 501 and 502 in both directions. The ports A, B are therefore also designated as inline ports. Port A comprises a receive section Rx and a transmit section Tx. The receive section Rx has been coupled with a receive buffer or intermediate memory 110. Intermediate memory 110 has been coupled with a control unit 120 which has been coupled with a transmit section Tx of port B. Intermediate memory 110 has furthermore been coupled with a functional unit 190 of the communication device 100. The functional unit 190 realises and controls functions of the communication device 100. For example, the functional unit 190 can monitor data traffic on the connection 500 and generate data packets with results of this monitoring. Furthermore, the functional unit 190 can be controlled or configured with, for example, data packets from the computer system 300 of FIG. 3. For the purpose of receiving data packets from the computer system 300, the functional unit 190 has been connected to the receive buffer 110 and can output data packets generated itself to control unit 120 via a transmit buffer or intermediate memory 130.

For data traffic in the opposite direction, the communication device 100 includes corresponding components. At port B the communication device 100 comprises a receive section Rx and a transmit section Tx. The receive section Rx has been coupled with a receive buffer or intermediate memory 111. Intermediate memory 111 has been coupled with a control unit 121 which has been coupled with the transmit section Tx of port A. In addition, intermediate memory 111 has been coupled with the functional unit 190, and the functional unit 190 has been coupled with a further transmit buffer or intermediate memory 131 for outputting data packets, which has been connected to control unit 121.

The intermediate memories 110 and 111 have a predetermined size. Data that are received by the receive sections Rx and that are input into the intermediate memories 110 and 111 are, for example, clocked in there time-synchronously, and after an intermediate storage are clocked out time-synchronously and output to the corresponding control units 120 and 121. The control units 120 and 121, in turn, forward the data to the corresponding transmit sections Tx. As a result, a forwarding of data through the communication device 100 from port A to port B and in the reverse direction from port B to port A is delayed by a defined time which depends on the size of the intermediate memories 110 and 111 and on the data rate at which the data are stored in the intermediate memories 110 and 111. By virtue of the constant delay, a transit-time of a data packet through the communication device 100 is well-defined and constant. As a result, a synchronisation method between the clocks 901 and 902 of FIG. 3 can be carried out in straightforward manner, for example in accordance with standard IEEE 1588.

Data packets that are received via the ports A or B and that are intended for the functional unit 190 can likewise be stored temporarily in the intermediate memories 110 and 111 and then forwarded to the functional unit 190. Data packets that the functional unit 190 would optionally like to send out via one or both of the ports A and B are firstly stored in the intermediate memory 130 or 131. The control unit 120 or 121 monitors the size of a data area not used in the corresponding intermediate memory 110 or 111. Expressed otherwise, the control unit 120 or 121 monitors, in the intermediate memory 110 or 111 assigned to it, whether a data gap in the data to be routed through is present in said intermediate memory. If the control unit 120 or 121 finds an appropriate data gap in the corresponding intermediate memory 110 or 111, this gap is used in order to send data from the intermediate memory 130 or 131.

To sum up, the mode of operation of the communication device 100 will be described in the following with reference to a flow chart 600 shown in FIG. 5. The incoming data packets at the inline ports A and B are received in step 601 and buffered in step 602 in an intermediate memory 110, 111 assigned to the port. An incoming data packet consequently has to pass through this intermediate memory before it is forwarded to the other inline port for renewed transmission. In step 603 it is examined whether a data gap is present in the intermediate memory or buffer 110 or 111. If no data gap is present, the data buffered in the intermediate memory 110, 111 are output in step 604 via the output. If in step 603 a data gap is found, the size of the data gap is determined in step 605. This can be done, for example, by examination of whether the intermediate memory 110 or 111 is empty. In this case a data gap that is at least as large as the intermediate memory 110 or 111 exists in the data stream. If, for example, intermediate memory 110 is empty, it has been ensured that no data packet is to be forwarded from port A to port B before the intermediate memory is filled up by a further incoming data packet via port A. Hence there is the possibility that a data packet generated by the functional unit 190 can be sent out at port B. To this end, it has to be ensured that the despatching of the data packet from the functional unit 190 has been concluded before the receive buffer 110 has again been filled up. Expressed otherwise, the data packet generated by the functional unit 190 is permitted to be at most as large as the gap in the data stream or (in the case of an empty intermediate memory 110) as the size of intermediate memory 110. This can be ensured by the functional unit 190, for example. Alternatively, the data gap can also be determined, for example in byte-precise manner, in the intermediate memory 110 or 111 by the control units 120 and 121. If in step 606 it is established that the data gap is large enough for the data of the functional unit 190, in step 607 the data of the functional unit 190 are output via port B. If in step 606 it is established that the data gap in the data stream is not large enough, no data are output from the functional unit 190, but the method is continued in step 601 with the reception of further data from the inputs A, B.

With the previously described communication device 100 a constant throughput-time for the data packets to be forwarded is obtained. From the point of view of the switches 501 and 502 or from the point of view of the systems that contain the clocks 901 and 902, this constant throughput-time can be regarded as an appreciable line-length. The throughput-time through the communication device 100 is independent of whether packets from the functional unit 190 are fed in or not in the gaps of the data stream on the connection 500 between the switches 501 and 502. Consequently the throughput-time of data packets between the ports A and B of the communication device 100 can continue to be compensated by a time-synchronisation mechanism, so that a synchronisation of the clocks 901 and 902 is made possible in straightforward manner.

As previously described, the size of the intermediate memories 110 and 111 determines the maximum size of the data packets that can be output from the functional unit 190. The intermediate memory 110, 111 cannot be smaller than the minimum packet size of the network technology being used. In the upward direction, however, there are no theoretical restrictions for the size of the intermediate memories 110, 111. However, practical considerations set limits here, since, on the one hand, the throughput-time increases with the size of the intermediate memories 110, 111, and, on the other hand, the probability of the condition occurring that the intermediate memory is empty decreases.

For the (probable) case that many of the data packets that are generated by the functional unit 190 are not as large as the size of the intermediate memories 110, 111, the method can be optimised, as already indicated previously. To this end, a wait is not observed in every case until the corresponding intermediate memory 110, 111 is completely empty, but rather a search is made for a gap in the data stream that is equally large as, or larger than, the next data packet that was output from the functional unit 190 for despatch into the corresponding intermediate memory 130, 131. As soon as, for example, control unit 120 has discovered a gap in intermediate memory 110, control unit 120 outputs data of intermediate memory 110 via the transmit section Tx of port B until the data gap has advanced into intermediate memory 110 and consequently, firstly, no data are to be output from intermediate memory 110. Then control unit 120 outputs data of the functional unit 190 from intermediate memory 130, provided the gap found in intermediate memory 110 is sufficiently large to output a complete data packet from intermediate memory 130 via the transmit section Tx of port B. If the gap in intermediate memory 110 is sufficiently large, where appropriate several data packets can also be output in succession from intermediate memory 130 via port B.

Although the method previously described has been described in connection with an Ethernet-based data network, the method can be used in any other data network.

1. Method for data transfer via a communication device, wherein the communication device is configured to receive data via an input (Rx, A) of the communication device, to output the data received via the input (Rx, A) via an output (Tx, B) of the communication device, and to output additional data via the output (Tx, B), said method comprising:
receiving the data via the input (Rx, A),
storing temporarily the data received via the input (Rx, A) in an intermediate data memory with a predetermined size,
outputting the data stored temporarily via the output (Tx, B),
determining a size of a data area not used by the received data in the intermediate data memory, and
outputting the additional data via the output (Tx, B) in a manner depending on the size of the data area not used by the received data in the intermediate data memory.

2. Method according to claim 1, wherein the determination of the size of the data area not used by the received data includes a determination of whether the intermediate data memory is empty.

3. Method according to claim 1, wherein the temporary storing of the received data includes a routing of the received data through the intermediate data memory at a predetermined speed.

4. Method according to claim 1, wherein the temporary storing of the received data includes a temporary storing of the received data in the intermediate data memory for a precisely predetermined time.

5. Method according to claim 1, wherein the additional data comprise data that were not received via the input (Rx, A).

6. Method according to claim 1, wherein the additional data comprise data that were generated by the communication device.

7. Method according to claim 1, wherein the data comprise data packets, each data packet comprising several data units, wherein the temporary storing of the received data includes a temporary storing of each data unit for a precisely predetermined time.

8. Method according to claim 1, wherein the additional data are output via the output (Tx, B) if the size of the data area not used by the received data in the intermediate data memory is larger than or equal to the size of a dataset of the additional data.

9. Method according to claim 1, further including a temporary storing of the additional data in an additional intermediate data memory before the additional data are output via the output (Tx, B).

10. Method according to claim 1, wherein the communication device is configured to receive further data via a further input (Rx, B) of the communication device, to output the further data received via the further input (Rx, B) via a further output (Tx, A) of the communication device, and to output further additional data via the further output (Tx, A), said method comprising:
receiving the further data via the further input (Rx, B),
storing temporarily the further data received via the further input (Rx, B) in a further intermediate data memory with a size that is equal to the predetermined size of the intermediate data memory,
outputting the data stored temporarily in the further intermediate data memory via the further output (Tx, A),
determining a size of a data area not used by the received further data in the further intermediate data memory, and
outputting the further additional data via the further output (Tx, A) in a manner depending on the size of the data area not used by the further received data in the further intermediate data memory.

11. Communication device comprising:
an input (Rx, A) for receiving data,
an output (Tx, B) for outputting data,
an intermediate data memory with a predetermined size, and
a control device is configured to store temporarily data received via the input (Rx, A) in the intermediate data memory, to output the data stored temporarily in the intermediate data memory via the output (Tx, B), to determine a size of a data area not used by the received data in the intermediate data memory, and to output additional data via the output (Tx, B) in a manner depending on the size of the data area not used by the received data in the intermediate data memory.

12. Communication device according to claim 11, wherein the control device is configured to determine the size of the data area not used by the received data by a determination of whether the intermediate data memory is empty.

13. Communication device according to claim 11, wherein the control device is configured to store temporarily the received data by routing of the received data through the intermediate data memory at a predetermined speed.

14. Communication device according to claim 11, wherein the control device is configured to store temporarily the received data by a temporary storing of the received data in the intermediate data memory for a precisely predetermined time.

15. Communication device according to claim 11, wherein the additional data comprise data that were not received via the input (Rx, A).

16. Communication device according to claim 11, wherein the additional data comprise data that were generated by the communication device.

17. Communication device according to claim 11, wherein the data comprise data packets, each data packet comprising several data units, wherein the control device is configured to store temporarily the received data by a temporary storing of each data unit for a precisely predetermined time.

18. Communication device according to claim 11, wherein the additional data are output via the output (Tx, B) if the size of the data area not used by the received data in the intermediate data memory is larger than or equal to the size of a dataset of the additional data.

19. Communication device according to claim 11, wherein the control device is configured to store temporarily the additional data in an additional intermediate data memory before the additional data are output via the output (Tx, B).

20. Communication device according to claim 11, wherein the communication device is configured to receive further data via a further input (Rx, B) of the communication device, to output the further data received via the further input (Rx, B) via a further output (Tx, A) of the communication device, and to output further additional data via the further output (Tx, A), wherein the control device is configured to:
receive the further data via the further input (Rx, B),
store temporarily the further data received via the further input (Rx, B) in a further intermediate data memory with a size that is equal to the predetermined size of the intermediate data memory,
output the data stored temporarily in the further intermediate data memory via the further output (Tx, A),
determine a size of a data area not used by the received further data in the further intermediate data memory, and
output the further additional data via the further output (Tx, A) in a manner depending on the size of the data area not used by the further received data in the further intermediate data memory.
